(19) United States
(12) Patent Application Publication
(10) Pub. No.: US 2020/0048452 A1
(43) Pub. Date: Feb. 13, 2020

(54) POLYOXYMETHYLENE FILM AND PREPARATION METHOD THEREOF

(71) Applicant: TANGSHAN KAILUAN CHEMICAL TECHNOLOGY CO.,LTD., Tangshan (CN)

(72) Inventors: Yatao WANG, Tangshan (CN); Xiaofeng MA, Tangshan (CN); Jianhua LI, Tangshan (CN); Lili LIU, Tangshan (CN); Xuehua GUO, Tangshan (CN); Hongjuan LI, Tangshan (CN); Wang JIN, Tangshan (CN); Dazhi YANG, Tangshan (CN); Lizheng GUAN, Tangshan (CN)

(73) Assignee: TANGSHAN KAILUAN CHEMICAL TECHNOLOGY CO.,LTD.

(21) Appl. No.: 16/563,918

(22) Filed: Sep. 8, 2019

Related U.S. Application Data
(63) Continuation of application No. PCT/CN2018/110642, filed on Oct. 17, 2018.

(30) Foreign Application Priority Data
Aug. 7, 2018 (CN) 201810890956.1

(51) Int. Cl. C08L 59/04; B29C 48/00; B29C 55/28; C08J 5/18; C08J 3/20

(52) U.S. Cl. CPC C08L 59/04; B29C 48/0018; B29C 48/022; B29K 2059/00; C08J 5/18; C08J 3/203; B29C 55/28

(57) ABSTRACT

The invention is a polyoxymethylene film and a preparation method. The polyoxymethylene film comprises: 96 to 98 parts by weight of polyoxymethylene resin, 0.5 to 2 parts by weight of nucleating agent, 0.5 to 1 parts by weight of antioxidant, and 0.5 to 1 parts by weight of formaldehyde absorbent. In view of the high crystallinity and fast crystallization rate of polyoxymethylene, blown film process is used to directly blowing the molten mass extruded through a die of a screw extruder to form a blown film bubble. It is easy to form thin neck and easy to break when stretching, so the method is beneficial to form polyoxymethylene film, and has high processing efficiency, and is suitable for industrialization. Copolymerization unit —CH₂—CH₂—O— is introduced into the molecular chain of polyoxymethylene and its ratio is increased, thereby effectively reducing the crystallization rate of the materials and making it easier to form a film.

### CROSS-REFERENCE TO RELATED APPLICATIONS

This application is a continuation of International Patent Application No. PCT/CN2018/110642 with an international filing date of Oct. 17, 2018, designating the United States, now pending, and further claims priority benefits to Chinese Patent Applications No. 201810890956.1, filed on Aug. 7, 2018. The contents of all of the aforementioned applications, including any intervening amendments thereto, are incorporated herein by reference.

### TECHNICAL FIELD

The present invention relates to a polyoxymethylene film and a preparation method thereof, belonging to the field of membrane technology.

### BACKGROUND

As a highly crystalline polymer, polyoxymethylene has excellent mechanical properties, abrasion resistance, dimensional stability, chemical resistance and self-lubricity. When preparing polyoxymethylene film with polyoxymethylene resin as raw material, the resulted polyoxymethylene film is expected to acquire the properties of polyformaldehyde raw materials, so it is possible to produce polyoxymethylene film with high strength and smooth surface, which is widely used in packaging, architecture, interior decoration and medicine.

However, polyoxymethylene has high crystallinity ranging from 50% to 75% and fast crystallization rate, and is easy to shrink to form wrinkles when cooling and is easy to form thin neck when stretching, so uneven stretching and breaking easily occur, and there is difficulty in biaxial stretching. Therefore, in the early study of polyoxymethylene film, hot roll uniaxial stretching method is an important research direction for preparing polyoxymethylene film. U.S. Pat. No. 3,875,284 disclosed a highly clear polyoxymethylene film and a preparation method thereof, wherein a polyoxymethylene film was prepared with hot roll stretching method using polyoxymethylene as raw materials. The thickness of the stretched polyoxymethylene film is reduced to 1/1.2-1/6 of the original thickness, so the prepared polyoxymethylene film has high transparency. In order to overcome the technical difficulties in the biaxial stretching of the polyoxymethylene film, especially that film quickly crystallizes after first stretching, causing difficulties in second stretching, a sequential biaxial stretching process is often adopted in the prior art after reducing the crystallinity and crystallization rate by changing the composition of the polyformaldehyde resin. Another choice is synchronous biaxial stretching technique, which comprises firstly preparing a film sheet, and then pre-heating it and stretching it into a film. However thin neck is easy to form in the stretching process, resulting in uneven stretching. Therefore additives are usually added to improve film forming ability of polyoxymethylene. In U.S. Pat. No. 4,946,930 a biaxially oriented polyoxymethylene film was prepared by using a two-step biaxial stretching method, comprising preparing a branched polymer by copolymerizing 1,4-butanediol diglycidyl ether, trioxane and cyclohexane, and blending with polyoxymethylene to improve the film forming properties, thus obtaining a polyoxymethylene film excellent in surface smoothness, with the number of spherulites at the surface of the film being at least 50/mm². Further, in a patent application CN201410040912.1, a polyoxymethylene nanoporous film with micro-nano double continuous multi-structure and a preparation method thereof were disclosed, wherein a polyoxymethylene film having a porous structure was prepared by using polyoxymethylene and polylactic acid as raw materials, and melting and compressing through an internal mixer, followed by etching. Such porous films can be used in the fields such as separation, lithium battery separator, etc.

### SUMMARY OF THE INVENTION

In order to overcome the problems that polyoxymethylene has poor film forming property, and is easy to break when stretching, etc., the present invention provides improvements in raw materials and preparation method. In one aspect, a polyoxymethylene film is prepared by one step molding with a blown film process, wherein molten extruded through a die of an extruder is directly blown up to a film, thereby overcoming the difficulties in forming polyoxymethylene film due to high crystallization and fast crystallization rate. In another aspect, comonomer proportion is increased to reduce crystallization rate and prolong crystallization time, thereby making the polyformaldehyde easier to be blown to film. Step by step slow cooling is used in the extrusion blown film process, thus the film is gradually cooled and is crystallized sufficiently, thereby preventing from local quenching crystallization which always causes insufficient stretching and uneven thickness. Further, a nucleating agent is introduced to promote uniform distribution of crystal nucleus, thereby improving regularity and compactness of crystal, which are beneficial to improve friction performance of the film surface.

In one aspect, the present invention provides a polyoxymethylene film, which comprises: 96 to 98 parts by weight of polyoxymethylene resin, 0.5 to 2 parts by weight of nucleating agent, 0.5 to 1 parts by weight of antioxidant, and 0.5 to 1 parts by weight of formaldehyde absorbent. Preferably a total weight is 100 parts by weight. The polyoxymethylene resin has a molecular formula of —(CH₂—O)ₙ—(CH₂—CH₂—O)—ₘ, wherein —(CH2-CH₂—O)—ₘ are copolymerization units accounting for a molar ratio 3% to 30%. Wherein, the polyoxymethylene resin has a melt index of 3 to 13 g/10 min. The nucleating agent is selected from the group consisting of polytetrafluoroethylene, polyvinylidene fluoride powder, and a mixture thereof. The formaldehyde absorbent is selected from the group consisting of melamine, hexamethylenediamine formaldehyde polycondensate, dicyandiamide, and a mixture thereof.

Antioxidants are conventional antioxidants,

In another aspect, the present invention provides a method for preparing polyoxymethylene film, comprising the following steps:

(1) forming a mixture by putting the above parts by weight of the polyoxymethylene, the nucleating agent, the antioxidant, and the formaldehyde absorbent into a high-speed mixer and mixing them uniformly;

(2) forming a tube by placing the mixture into a hopper of a screw extruder, melting the mixture to obtain a molten mass, and extruding the molten mass through a die;

(3) forming polyoxymethylene films by a blown film process, comprising stretching the tube, which is vertical, upward and blowing compressed air into the tube to inflate radially to form a blown film bubble, and simultaneously cooling the blown film bubble by using a multistage air cooling ring around the outer surface of the bubble, then collapsing the cooled blown film bubble by passing through a collapsing frame and thereafter through pulling rollers, then solidifying, cutting and winding onto rolls.

Parameters of the process are as follows: in the step (2), the screw extruder has a temperature of 170° C. to 185° C. at a feeding section, 190° C. to 200° C. at a plasticization section, 195° C. to 210° C. at a homogenization section, and 205° C. to 220° C. at a filter mesh, and the die has a temperature of 205° C. to 220° C., and the main engine of the single screw extruder has a screw rotation speed of 40 r/min. In the step (3), the blown film bubble has a Blown Up Ratio of 1.4 to 2.5 and a Stretch Ratio of 2 to 4, and the pulling rollers have a speed of 12˜24 m/min. The multistage air cooling ring preferably comprises 3 air cooling rings to perform step-by-step slow cooling, and the temperature from bottom to top in the axial direction of the 3 air cooling rings are 160° C. to 140° C., 130° C. to 100° C. and 80° C. to 30° C. respectively. The air cooling ring with the temperature of 160° C. to 140° C. preferably has an axial length of 10 mm, the air cooling ring with the temperature of 130° C. to 100° C. has an axial length of 10 mm, and the air cooling ring with the temperature of 80° C. to 30° C. has an axial length of 8 mm, and each of the air cooling ring has an air pressure of 0.2 MPa to 0.4 MPa.

The present invention has the following technical characteristics and effects:

In view of the characteristics of polyoxymethylene materials, in the present invention, polyoxymethylene is used as a main raw material, and polyoxymethylene film is prepared by a blown film process. The materials are extruded through a die at head of an extruder, blown to form a blown film bubble, and cooled by using a multistage air cooling ring, during which a series of changes occurs in viscosity and phase, etc. Problems such as uneven thickness, local high crystallization, wrinkles, etc. are overcome by reasonable control of the temperature, blowing up, stretching and cooling of the materials at each section.

In the present invention, the crystallization rate of polyoxymethylene is changed by adjusting the proportion of the copolymerization unit —CH₂—CH₂—O— in the molecular chain. As the proportion increases, the crystallization rate gradually decreases and the semi-crystallization time is prolonged. However, when the proportion of the copolymerization unit exceeds a certain ratio, it will affect the mechanical properties of the polyoxymethylene film.

By adding a nucleating agent, the original large spherulites of the polyoxymethylene film are refined and the size is reduced, thereby improving the regularity and the compactness of crystals, which are beneficial to effectively reduce the friction coefficient of the polyoxymethylene film.

The nucleating agent used in the present invention is polytetrafluoroethylene or polyvinylidene fluoride, which has excellent friction performance. Some of the additives which are not used as crystal nucleus can improve the surface smoothness of the materials and reduce the friction coefficient.

In view of the material characteristics of polyoxymethylene such as narrow processing window, poor stability, and easy to occur zipper decomposition, copolymerization unit —CH₂—CH₂—O— is introduced into the present invention, and the proportion of which is increased to improve the thermal stability of the polyoxymethylene. In addition, antioxidant is introduced to inhibit oxidative decomposition of the materials at high temperature. Further, formaldehyde absorbent is introduced to control the formaldehyde content in the system so as to prevent it from further promoting decomposing of the molten raw materials, thereby effectively maintaining the characteristics of the raw material and reducing the deterioration of the processing environment during the blown film process.

The blown film process in the present invention is quite different from the extrusion stretching process. The blown film process is characterized by extruding the polyoxymethylene molten mass, followed by blowing compressed air to directly form a blown film bubble, and cooling by using a multistage air cooling ring, so that the crystallization time of the film is more sufficient, which is beneficial to increase the crystallinity and reduce the friction coefficient.

### BRIEF DESCRIPTION OF THE DRAWINGS

FIG. 1 shows the spherulite size of polyoxymethylene in which the copolymerization unit accounts for 10%.

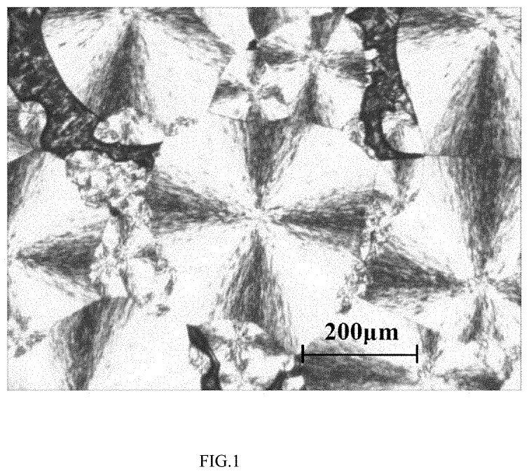

FIG. 2 shows the spherulite size of polyoxymethylene in which the copolymerization unit accounts for 10% and a nucleating agent is added.

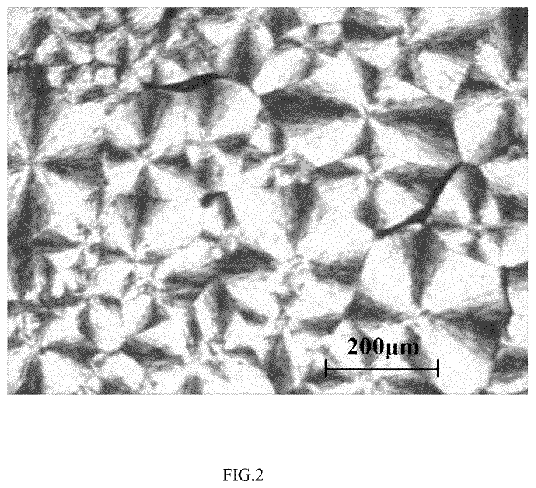

FIG. 3 is a graph showing the crystallinity-time curve of polyoxymethylene with different proportions of copolymerization units.

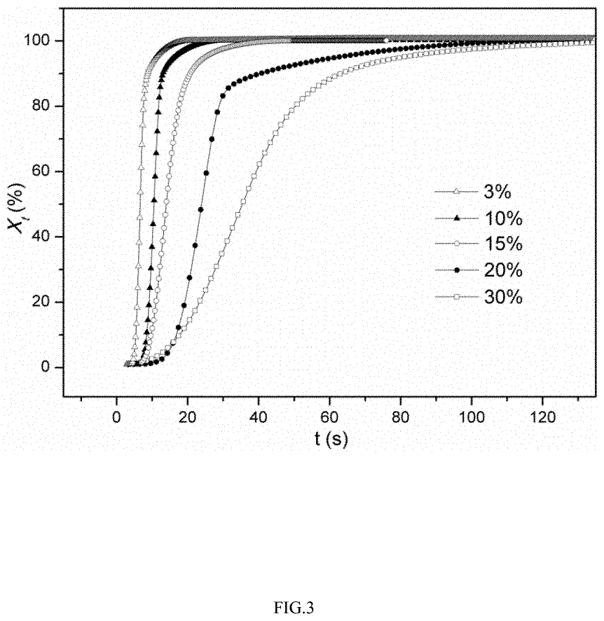

### DETAILED DESCRIPTION OF EMBODIMENTS

The present invention will now be described in detail with reference to the embodiments, but the invention is not limited to the following embodiments.

### Embodiment 1

The polyoxymethylene film in present embodiment is prepared by the following preparation method at the following raw material ratio.

The polyoxymethylene film comprises: 98 parts by weight of polyoxymethylene resin, 1 parts by weight of polyvinylidene fluoride, 0.5 parts by weight of antioxidant, and 0.5 parts by weight of melamine, wherein —(CH₂—CH₂—O)—ₘ copolymerization units account for a molar ratio 3% in the polyoxymethylene molecular structure.

A method for preparing polyoxymethylene film comprises the following steps:

(1) forming a mixture by putting the above parts by weight of the polyoxymethylene resin having a melt index of 13 g/10 min, the polyvinylidene fluoride, the antioxidant, and the melamine into a high-speed mixer and mixing them uniformly;

(2) forming a tube by placing the mixture into a hopper of a screw extruder, melting the mixture to obtain a molten mass, and extruding the molten mass through a die;

(3) forming polyoxymethylene films by a blown film process, comprising stretching the tube upward and blowing compressed air into the tube to form a blown film bubble, and simultaneously cooling the blown film bubble by using a multistage air cooling ring around the outer surface of the bubble, then collapsing the cooled blown film bubble by passing through a collapsing frame and thereafter through pulling rollers, then solidifying, cutting and winding onto rolls.

Parameters of the process are as follows: in the step (2), the screw extruder has a temperature of 170° C. to 185° C. at a feeding section, 190° C. to 200° C. at a plasticization section, 195° C. to 210° C. at a homogenization section, and 205° C. to 220° C. at a filter mesh, and the die has a temperature of 205° C. to 220° C., and the screw extruder has a screw rotation speed of 40 r/min; in the step (3), the blown film bubble has a Blown Up Ratio of 1.4 and a Stretch Ratio of 2, and the pulling rollers have a speed of 12 m/min, and the temperature of the 3 air cooling rings are 160° C., 130° C. and 80° C. respectively, and the air cooling ring with the temperature of 160° C. has an axial length of 10 mm, the air cooling ring with the temperature of 130° C. has an axial length of 10 mm, and the air cooling ring with the temperature of 80° C. has an axial length of 8 mm, and each of the air cooling ring has an air pressure of 0.4 MPa.

### Embodiment 2

The polyoxymethylene film in present embodiment is prepared by the following preparation method at the following raw material ratio.

The polyoxymethylene film comprises: 97.5 parts by weight of polyoxymethylene resin, 0.5 parts by weight of polyvinylidene fluoride, 1 parts by weight of antioxidant, 0.5 parts by weight of melamine, and 0.5 parts by weight of dicyanodiamide, wherein —(CH₂—CH₂—O)—ₘ are copolymerization units accounting for a molar ratio 10% in the polyoxymethylene molecular structure.

A method for preparing polyoxymethylene film comprises the following steps:

(1) forming a mixture by putting the above parts by weight of the polyoxymethylene resin having a melt index of 9 g/10 min, the polyvinylidene fluoride, the antioxidant, and the melamine into a high-speed mixer and mixing them uniformly;

(2) forming a tube by placing the mixture into a hopper of a screw extruder, melting the mixture to obtain a molten mass, and extruding the molten mass through a die;

(3) forming polyoxymethylene films by a blown film process, comprising stretching the tube upward and blowing compressed air into the tube to form a blown film bubble, and simultaneously cooling the blown film bubble by using a multistage air cooling ring around the outer surface of the bubble, then collapsing the cooled blown film bubble by passing through a collapsing frame and thereafter through pulling rollers, then solidifying, cutting and winding onto rolls.

Parameters of the process are as follows: in the step (2), the screw extruder has a temperature of 170° C. to 185° C. at a feeding section, 190° C. to 200° C. at a plasticization section, 195° C. to 210° C. at a homogenization section, and 205° C. to 220° C. at a filter mesh, and the die has a temperature of 205° C. to 220° C., and the main engine of the single screw extruder has a screw rotation speed of 40 r/min; in the step (3), the blown film bubble has a Blown Up Ratio of 2 and a Stretch Ratio of 3, and the pulling rollers have a speed of 18 m/min, and the temperature of the 3 air cooling rings are 150° C., 120° C. and 60° C. respectively, and the air cooling ring with the temperature of 150° C. has an axial length of 10 m, the air cooling ring with the temperature of 120° C. has an axial length of 10 mm, and the air cooling ring with the temperature of 60° C. has an axial length of 8 mm, and each of the air cooling ring has an air pressure of 0.2 MPa.

### Embodiment 3

The polyoxymethylene film in present embodiment is prepared by the following preparation method at the following raw material ratio.

The polyoxymethylene film comprises: 96 parts by weight of polyoxymethylene resin, 1 parts by weight of polytetrafluoroethylene, 1 parts by weight of polyvinylidene fluoride, 1 parts by weight of antioxidant, and 1 parts by weight of hexanediamine formaldehyde polycondensation, wherein —(CH₂—CH₂—O)—ₘ are copolymerization units accounting for a molar ratio 20% in the polyoxymethylene molecular structure.

A method for preparing polyoxymethylene film having high barrier resistance comprises the following steps:

(1) forming a mixture by putting the above parts by weight of the polyoxymethylene resin having a melt index of 3 g/10 min, the polytetrafluoroethylene, the antioxidant, and the hexanediamine formaldehyde polycondensation into a high-speed mixer and mixing them uniformly;

(2) forming a tube by placing the mixture into a hopper of a screw extruder, melting the mixture to obtain a molten mass, and extruding the molten mass through a die;

(3) forming polyoxymethylene films by a blown film process, comprising stretching the tube upward and blowing compressed air into the tube to form a blown film bubble, and simultaneously cooling the blown film bubble by using a multistage air cooling ring around the outer surface of the bubble, then collapsing the cooled blown film bubble by passing through a collapsing frame and thereafter through pulling rollers, then solidifying, cutting and winding onto rolls.

Parameters of the process are as follows: in the step (1), the screw extruder has a temperature of 170° C. to 185° C. at a feeding section, 190° C. to 200° C. at a plasticization section, 195° C. to 210° C. at a homogenization section, and 205° C. to 220° C. at a filter mesh, and the die has a temperature of 205° C. to 220° C., and the main engine of the single screw extruder has a screw rotation speed of 40 r/min; in the step (2), the blown film bubble has a Blown Up Ratio of 2.5 and a Stretch Ratio of 4, and the pulling rollers have a speed of 24 m/min, and the temperature of the 3 air cooling rings are 150° C., 100° C. and 30° C. respectively, and the air cooling ring with the temperature of 150° C. has an axial length of 10 mm, the air cooling ring with the temperature of 100° C. has an axial length of 10 mm, and the air cooling ring with the temperature of 30° C. has an axial length of 8 mm, and each of the air cooling ring has an air pressure of 0.4 MPa.

### Embodiment 4

The polyoxymethylene film in present embodiment is prepared by the following preparation method at the following raw material ratio.

The polyoxymethylene film comprises: 96 parts by weight of polyoxymethylene resin, 1 parts by weight of polytetrafluoroethylene, 1 parts by weight of polyvinylidene fluoride, 1 parts by weight of antioxidant, and 1 parts by weight of hexanediamine formaldehyde polycondensation, wherein —(CH₂—CH₂—O)—ₘ are copolymerization units accounting for a molar ratio 30% in the polyoxymethylene molecular structure.

A method for preparing polyoxymethylene film having high barrier resistance comprises the following steps:

(1) forming a mixture by putting the above parts by weight of the polyoxymethylene resin having a melt index of 3 g/10 min, the polytetrafluoroethylene, the antioxidant, and the hexanediamine formaldehyde polycondensation into a high-speed mixer and mixing them uniformly;

(2) forming a tube by placing the mixture into a hopper of a screw extruder, melting the mixture to obtain a molten mass, and extruding the molten mass through a die;

(3) forming polyoxymethylene films by a blown film process, comprising stretching the tube upward and blowing compressed air into the tube to form a blown film bubble, and simultaneously cooling the blown film bubble by using a multistage air cooling ring around the outer surface of the bubble, then collapsing the cooled blown film bubble by passing through a collapsing frame and thereafter through pulling rollers, then solidifying, cutting and winding onto rolls.

Parameters of the process are as follows: in the step (1), the screw extruder has a temperature of 170° C. to 185° C. at a feeding section, 190° C. to 200° C. at a plasticization section, 195° C. to 210° C. at a homogenization section, and 205° C. to 220° C. at a filter mesh, and the die has a temperature of 205° C. to 220° C., and the main engine of the single screw extruder has a screw rotation speed of 40 r/min; in the step (2), the blown film bubble has a Blown Up Ratio of 2.5 and a Stretch Ratio of 4, and the pulling rollers have a speed of 24 m/min, and the temperature of the 3 air cooling rings are 140° C., 100° C. and 30° C. respectively, and the air cooling ring with the temperature of 140° C. has an axial length of 10 mm, the air cooling ring with the temperature of 100° C. has an axial length of 10 mm, and the air cooling ring with the temperature of 30° C. has an axial length of 8 mm, and each of the air cooling ring has an air pressure of 0.4 MPa.

The performance parameters of the polyoxymethylene films prepared in the embodiments of the present invention are shown in Table 1.

TABLE 1
Performance parameters of the polyoxymethylene films

| | Embodiment No. | | | |
|---|---|---|---|---|
| Performance parameters | 1 | 2 | 3 | 4 |
| Film thickness/μm | 300 | 140 | 30 | 30 |
| Mean variation of film thickness/% | ±13 | ±11 | ±10 | ±9 |
| Coefficient of dynamic friction | 0.16 | 0.13 | 0.11 | 0.11 |
| Transverse tensile strength/MPa | 76 | 83 | 113 | 108 |
| Longitudinal tensile strength/MPa | 78 | 91 | 98 | 93 |

The effect of the ratio of copolymerization units on the semi-crystallization time of polyoxymethylene is shown in Table 2.

TABLE 2
Semi-crystallization time of polyformaldehyde
with different ratios of copolymerization units

| Samples | 3% | 10% | 15% | 20% | 30% |
|---|---|---|---|---|---|
| t½ (S) | 115 | 121 | 132 | 135 | 142 |

We claim:

1. A method for preparing polyoxymethylene film, the polyoxymethylene film comprising:
96 to 98 parts by weight of polyoxymethylene resin,
0.5 to 2 parts by weight of nucleating agent,
0.5 to 1 parts by weight of antioxidant, and
0.5 to 1 parts by weight of formaldehyde absorbent,
wherein the polyoxymethylene resin has a molecular formula of —(CH₂—O)ₙ—(CH₂—CH₂—O)—ₘ, wherein —(CH₂—CH₂—O)—ₘ are copolymerization units accounting for a molar ratio 3% to 30%,
the method comprising the following steps:
(1) forming a mixture by putting the above parts by weight of the polyoxymethylene, the nucleating agent, the antioxidant, and the formaldehyde absorbent into a high-speed mixer and mixing them uniformly;
(2) forming a tube by placing the mixture into a hopper of a screw extruder, melting the mixture to obtain a molten mass, and extruding the molten mass through a die;
(3) forming polyoxymethylene films by a blown film process, comprising stretching the tube upward and blowing compressed air into the tube to form a blown film bubble, and simultaneously cooling the blown film bubble by using a multistage air cooling ring around the outer surface of the bubble, then collapsing the cooled blown film bubble by passing through a collapsing frame and thereafter through pulling rollers, then solidifying, cutting and winding onto rolls.

2. The method of claim 1, wherein, in the step (2), the screw extruder has a temperature of 170° C. to 185° C. at a feeding section, 190° C. to 200° C. at a plasticization section, 195° C. to 210° C. at a homogenization section, and 205° C. to 220° C. at a filter mesh, and the die has a temperature of 205° C. to 220° C., and the screw extruder has a screw rotation speed of 40 r/min.

3. The method of claim 1, wherein, in the step (3), the blown film bubble has a Blown Up Ratio of 1.4 to 2.5 and a Stretch Ratio of 2 to 4, and the pulling rollers have a speed of 12˜24 m/min.

4. The method of claim 1, wherein, in the step (3), the multistage air cooling ring comprises at least 3 air cooling rings to perform step-by-step slow cooling, the temperature of which are gradually decreased from bottom to top in the axial direction.

5. The method of claim 4, wherein, in the step (3), the temperature of the 3 air cooling rings are 160° C. to 140° C., 130° C. to 100° C. and 80° C. to 30° C. respectively.

6. The method of claim 5, wherein, in the step (3), the air cooling ring with the temperature of 160° C. to 140° C. preferably has an axial length of 10 mm, the air cooling ring with the temperature of 130° C. to 100° C. has an axial length of 10 mm, and the air cooling ring with the temperature of 80° C. to 30° C. has an axial length of 8 mm, and each of the air cooling rings has an air pressure of 0.2 MPa to 0.4 MPa.

7. The method of claim 1, wherein, the polyoxymethylene resin has a melt index of 3 to 13 g/10 min.

8. The method of claim 1, wherein, the nucleating agent is selected from the group consisting of polytetrafluoroethylene, polyvinylidene fluoride powder, and a mixture thereof.

9. The method of claim 1, wherein, the formaldehyde absorbent is selected from the group consisting of melamine, hexamethylenediamine formaldehyde polycondensate, dicyandiamide, and a mixture thereof.

10. A polyoxymethylene film prepared by the method according to claim 1.

11. A polyoxymethylene film prepared by the method according to claim 2.

12. A polyoxymethylene film prepared by the method according to claim 3.

13. A polyoxymethylene film prepared by the method according to claim 4.

14. A polyoxymethylene film prepared by the method according to claim 5.

15. A polyoxymethylene film prepared by the method according to claim 6.

16. A polyoxymethylene film prepared by the method according to claim 7.

17. A polyoxymethylene film prepared by the method according to claim 8.

18. A polyoxymethylene film prepared by the method according to claim 9.
